(19) United States
(12) Patent Application Publication
(10) Pub. No.: US 2019/0042155 A1
(43) Pub. Date: Feb. 7, 2019

(54) OVERLOADING MEMORY ADDRESS FIELDS WHILE MAINTAINING ADDRESS BOUNDARY CONSTRAINT COMPLIANCE

(71) Applicant: Intel Corporation, Santa Clara, CA (US)

(72) Inventors: Eng Hun Ooi, Georgetown (MY); Shrinivas Venkatraman, Folsom, CA (US); Kuan Hua Tan, Coquitlam (CA); Ang Li, Coquitlam (CA); Sahar Khalili, Vancouver (CA); Su Wei Lim, Bayan Lepas (MY); Robert Royer, JR., Portland, OR (US)

(73) Assignee: Intel Corporation, Santa Clara, CA (US)

(21) Appl. No.: 15/978,766

(22) Filed: May 14, 2018

(51) Int. Cl. G06F 3/06; G06F 13/16; G06F 13/42; G06F 12/06

(52) U.S. Cl. CPC G06F 3/0659; G06F 3/0604; G06F 3/0673; G06F 2212/1016; G06F 13/4282; G06F 12/06; G06F 2213/0026; G06F 13/1668

(57) ABSTRACT

Systems, apparatuses and methods may provide for technology to add non-address metadata to a memory address field of a transaction layer packet (TLP), wherein the non-address metadata includes one or more vendor-specific attributes. Additionally, the technology may coordinate between a transmitter and a receiver to prevent the TLP from violating an address boundary constraint associated with an interface. In one example, the address boundary constraint prohibits an address and length combination of the TLP from crossing a 4-KB boundary.

### TECHNICAL FIELD

Embodiments generally relate to memory structures.

### BACKGROUND

PCI-e (Peripheral Components Interconnect Express, e.g., PCI Express Base Specification 3.0, Nov. 10, 2010, PCI Special Interest Group) is a serial computer expansion bus standard that may enable a host device to issue read and write requests to a memory device over a high speed link. As memory devices evolve, however, supporting new functionality within the framework of the PCI-e standard may present a challenge.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an interface between a host device and a memory device according to an embodiment;

FIG. 2 is a flowchart of an example of a method of exchanging packets over an interface according to an embodiment;

FIG. 3A is a flowchart of an example of a method of coordinating the overloading of a lower bit range of a memory address field according to an embodiment;

FIG. 3B is a flowchart of an example of a method of coordinating the overloading of an upper bit range of a memory address field according to an embodiment;

FIG. 4 is a schematic diagram of an example of a transmitter and a receiver according to an embodiment;

FIG. 5 is a block diagram of an example of a computing system according to an embodiment; and

FIG. 6 is an illustration of an example of a semiconductor package apparatus according to an embodiment.

### DESCRIPTION OF EMBODIMENTS

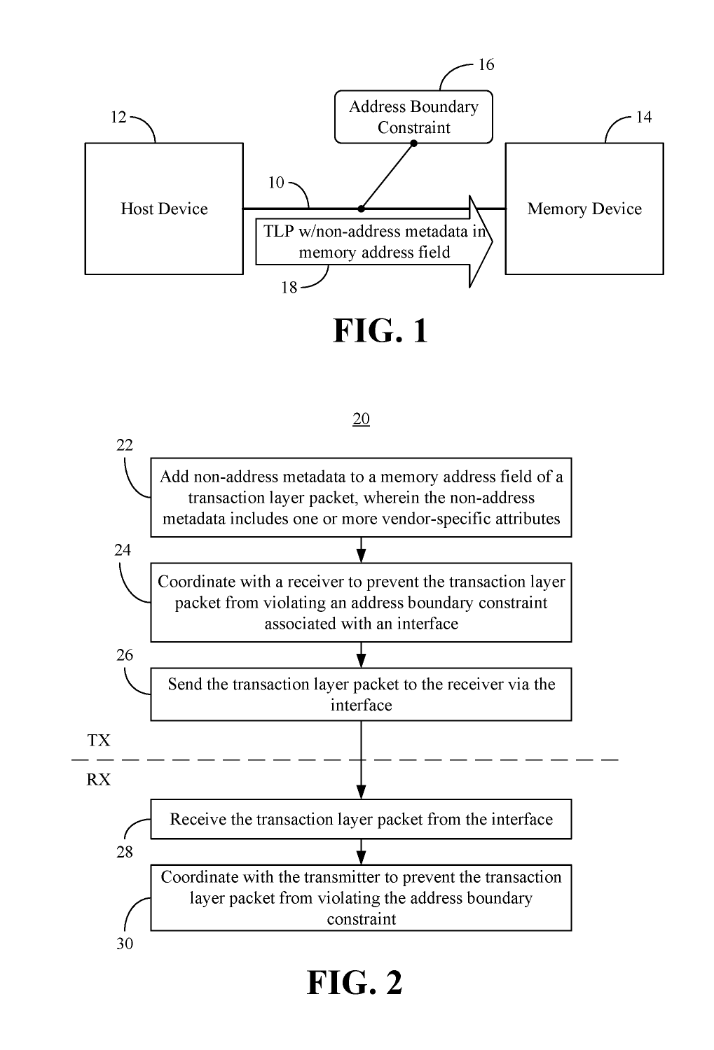

Turning now to FIG. 1, an interface 10 between a host device 12 (e.g., root port controller) and an endpoint device such as, for example, a memory device 14, is shown. The interface 10 may generally be an externally visible (e.g., off-chip) bus that complies with a standard such as, for example, a PCI-e standard. The standard of the illustrated interface 10 has an address boundary constraint 16 that prohibits address and length combinations of transaction layer packets (e.g., memory write requests/packets, memory read requests/packets) transmitted across the interface 10 from crossing a boundary (e.g., 4-KB boundary).

For example, if a transaction layer packet (TLP) requesting a write to hexadecimal address E00 (i.e., E00h, which is 3584 bytes), the value E00h may be stored to the memory address field (e.g., bits [63:8]) of the TLP. Additionally, if the TLP has a length of 512 bytes (i.e., 200h), the TLP would be just at a 4-KB address boundary (e.g., 3584 bytes+512 bytes=4096 bytes). Thus, the address boundary constraint 16 would prohibit such a TLP from containing either an address higher than E00h (combined with the length of 512 bytes) or having a length greater than 512 bytes (combined with the E00h address). In the illustrated example, a TLP 18 is “overloaded” with non-address metadata in the memory address field of the TLP 18. The non-address metadata may include one or more bits defining vendor-specific attributes such as, for example, chunk indication attributes, full/partial transaction attributes, compression attributes, etc., wherein the non-address metadata enables functionality beyond the standard (e.g., PCI-e) of the interface 10. The non-address metadata may therefore provide the receiver with control/status information that may or may not be related to the specific transaction that carries the attributes across the interface 10. As will be discussed in greater detail, the host device 12 and the memory device 14 may coordinate with one another to ensure that the overloaded TLP 18 does not violate the address boundary constraint 16.

FIG. 2 shows a method 20 of exchanging packets over an interface. The method 20 may generally be implemented by a host device such as, for example, the host device 12 (FIG. 1) and/or a memory device 14 such as, for example, the memory device 14 (FIG. 1), already discussed. More particularly, the method 20 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 20 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated transmitter (TX) processing block 22 provides for adding non-address metadata to a memory address field of a TLP, wherein the non-address metadata includes one or more vendor-specific attributes. The TLP may be a memory write packet (e.g., MWr), a memory read packet (e.g., MRd), and so forth. As will be discussed in greater detail, the non-address metadata may be added to either a lower bit range of the memory address field or an upper bit range of the memory address field. Transmitter processing block 24 coordinates with a receiver to prevent the TLP from violating an address boundary constraint associated with an interface. In one example, the address boundary constraint prohibits an address and length combination of the TLP from crossing a 4-KB boundary. Other address boundary constraints (e.g., 8-KB boundary) may also be used. The TLP may be sent to the receiver at transmitter processing block 26 via the interface. Illustrated receiver (RX) processing block 28 provides for receiving the TLP from the interface, wherein receiver processing block 30 may coordinate with the transmitter to prevent the TLP from violating the address boundary constraint. In one example, the TLP is exchanged via a PCI-e interface.

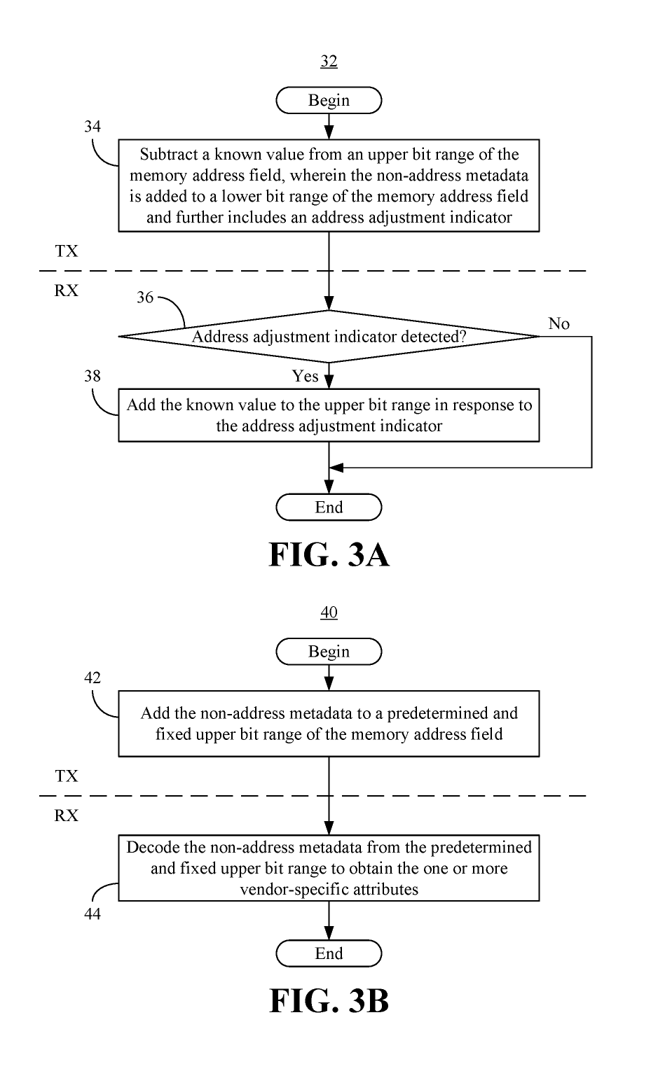

FIG. 3A shows a method 32 of coordinating the overloading of a lower bit range of a memory address field. The method 32, which may be readily substituted for blocks 24 and 30 (FIG. 2), already discussed, may generally be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated transmitter processing block 34 provides for subtracting a known value (e.g., offset) from an upper bit range (e.g., bits [MSB:n]) of the memory address field, wherein the non-address metadata is added to a lower bit range (e.g., bits [n−1:2], with bits [1:0] being reserved for TLP processing hints/TPH). The known amount may be 2ⁿ, 2⁽ⁿ⁻¹⁾ or any value (or set of values) that is mutually supported by both the transmitter and receiver controllers.

For example, if a TLP requests a write to hexadecimal address F00 (i.e., F00h, which is 3840 bytes), the value F00h may be stored to the upper bit range of the memory address field (e.g., bits [63:8]). Additionally, if the TLP has a length of 256 bytes (i.e., 100h) and the value 04h is added to the lower bit range (e.g., bits [7:0]) of the memory address field, the TLP would cross the address boundary (e.g., 3840 bytes+256 bytes+4 bytes=4100 bytes). Subtracting a known value such as, for example, 100h (i.e., 256 bytes) from the upper bit range of the memory address field (i.e., F00h−100h=E00h) therefore prevents the TLP from violating the address boundary constraint (i.e., 4100 bytes−256 bytes=3844 bytes <4096 bytes) when transmitted across the interface. The illustrated subtraction may be conducted before or after the write address is stored to the upper bit range of the memory address field. In the illustrated example, the non-address metadata further includes an address adjustment indicator (e.g., setting bit [2] in the memory address field to “1”), which signals to the receiver that the write address has been adjusted.

Receiver processing block 36 provides for determining whether an address adjustment indicator is detected in a received TLP. In one example, block 36 includes determining whether a particular bit (e.g., bit [2]) in the memory address field is set. If so, illustrated receiver processing block 38 adds the known value to the upper bit range in response to the address adjustment indicator. Thus, in the example immediately above, 100h would be added to E00h to obtain the original write address F00h. If the address adjustment indicator is not detected, the illustrated method 32 bypasses receiver processing block 38.

The illustrated method 32 is particularly advantageous if the access granularity is greater than DWord (e.g., 32-bit) granularity. For example, if the access granularity is always in 256-byte increments, then the lower bit range (e.g., bits [7:2]) of the memory address field may not be needed for addressing. Table I below illustrates an example.

TABLE I

| Memory TLP address | | |
|---|---|---|
| [MSB:n] | Memory TLP Address [n-1:2] | Address [1:0] |
| Transmitted* memory | vendor-specific attributes | “00” or TPH |
| address [MSB:n] | and/or metadata | [1:0] |
| | address adjustment indication | |
| | by transmitter | |
| | reserved bit(s) | |

FIG. 3B shows a method 40 of coordinating the overloading of an upper bit range of a memory address field. The method 40, which may be readily substituted for blocks 24 and 30 (FIG. 2), already discussed, may generally be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated transmitter processing block 42 provides for adding non-address metadata to a predetermined and fixed upper bit range (e.g., bits [64:57]) of the memory address field. Such an approach may limit the maximum memory addressability (e.g., less than full 64-bit addressability) and may increase the size of the base address register (BAR, e.g., in the configuration space header), which is used by the host device during enumeration to allocate memory space. Receiver processing block 44 may decode the non-address metadata from the predetermined and fixed upper bit range to obtain the one or more vendor-specific attributes.

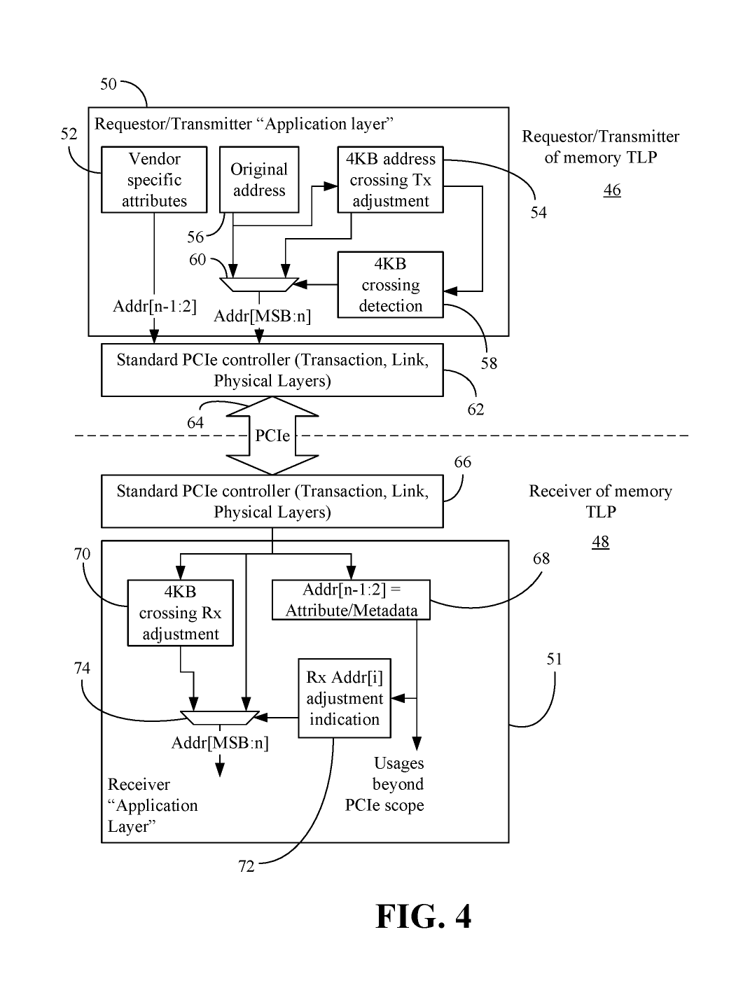

Turning now to FIG. 4, a transmitter 46 (e.g., requester) and a receiver 48 are shown in which a lower bit range of a memory address field in a transaction layer packet is overloaded. The illustrated architecture may therefore implement one or more aspects of the method 20 (FIG. 2) and/or the method 32 (FIG. 3A), already discussed. In the illustrated example, an application layer 50 overloads bits [n−1:2] of a memory address field with vendor specific attributes 52. An adjustment 54 to (e.g., known value subtraction from) an original address 56 may be made, wherein a boundary crossing detection 58 controls a multiplexer 60 to incorporate either the original address 56 (e.g., if the 4-KB address boundary is not crossed) or the adjusted address (e.g., if the 4-KB address boundary is crossed) to bits [MSB:n].

A first interface controller 62 (e.g., standard PCI-e controller including transaction, link and physical layers) may send the transaction layer packet to the receiver 48 via an interface 64. A second interface controller 66 may receive the transaction layer packet from the interface 64, wherein an application layer 51 of the receiver 48 may extract 68 the non-address metadata from the lower bit range (e.g., bits [n−1:2]). Additionally, an adjustment 70 to (e.g., known value addition to) the upper bit range may be made, wherein an address adjustment detection 72 may control a multiplexer 74 to output (e.g., bits [MSB:n]) either the adjusted address or the unadjusted address. As already noted, the non-address metadata may include vendor-specific attributes that enable performance-enhancing usages beyond the scope of the standard associated with the interface 64.

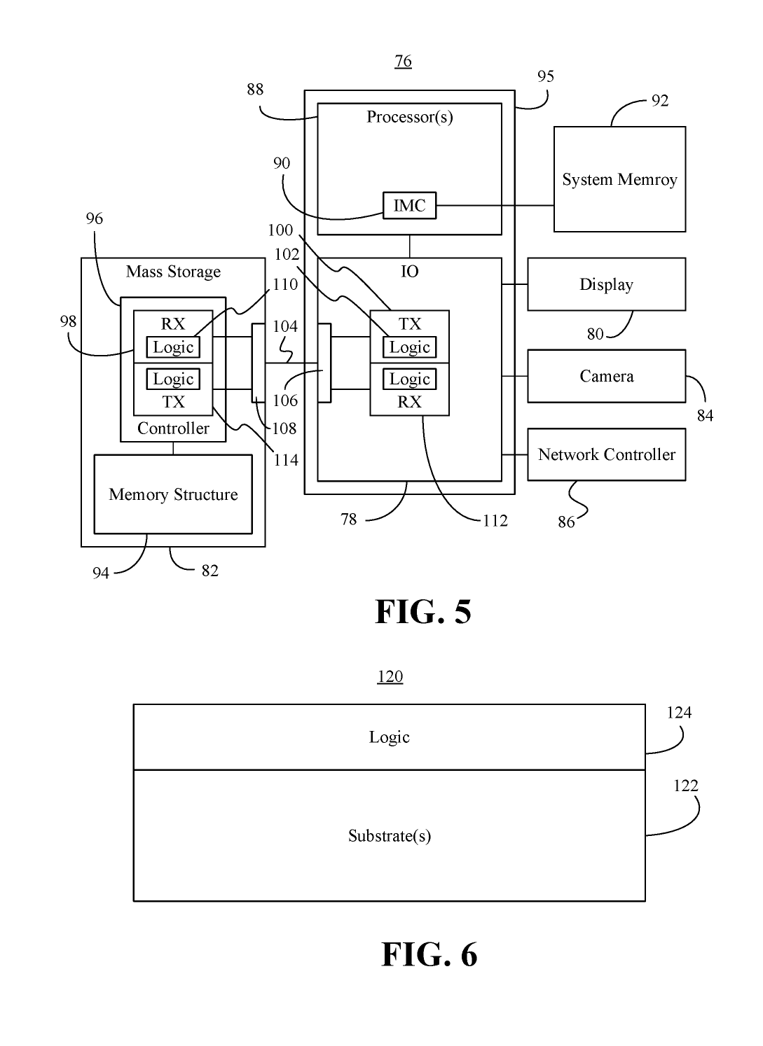

Turning now to FIG. 5, a performance-enhanced computing system 76 is shown. The system 76 may generally implement one or more aspects of the method 20 (FIG. 2), the method 32 (FIG. 3A) and/or the method 40 (FIG. 3B). More particularly, the system 76 may be part of a server, desktop computer, notebook computer, tablet computer, convertible tablet, smart television (TV), personal digital assistant (PDA), mobile Internet device (MID), smart phone, wearable device, media player, vehicle, robot, etc., or any combination thereof. In the illustrated example, an input/output (TO) module 78 (e.g., root port controller) functions as a host processor and is communicatively coupled to a display 80 (e.g., liquid crystal display/LCD, light emitting diode/LED display, touch screen), mass storage 82 (e.g., hard disk drive/HDD, optical disk, flash memory, solid state drive/SSD), a camera 84 and a network controller 86 (e.g., wired, wireless).

The system 76 may also include a processor 88 (e.g., central processing unit/CPU) that includes an integrated memory controller (IMC) 90, wherein the illustrated IMC 90 communicates with a system memory 92 over a bus or other suitable communication interface. The processor 88 and the IO module 78 may be integrated onto a shared semiconductor die 95 in a system on chip (SoC) architecture.

The illustrated mass storage 82 includes a memory structure 94 and a memory controller 96 (e.g., endpoint) coupled to the memory structure 94, wherein the memory controller 96 includes a receiver 98. The IO module 78 may include a transmitter 100 that has first logic 102 (e.g., logic instructions, configurable logic, fixed-functionality hardware logic, etc., or any combination thereof) to add non-address metadata to a memory address field of a transaction layer packet, wherein the non-address metadata includes one or more vendor-specific attributes (e.g., chunk indication attributes, full/partial transaction attributes, compression attributes, etc., or any combination thereof). Additionally, the first logic 102 may coordinate with the receiver 98 to prevent the transaction layer packet from violating an address boundary constraint associated with an interface 104 (e.g., PCI-e interface). A first interface controller 106 may be coupled to the interface 104 and the transmitter 100, wherein the first interface controller 106 is to send (e.g., during operation) the transaction layer packet to the receiver 98 via the interface 104. The illustrated mass storage 82 also includes a second interface controller 108 coupled to the interface 104 and the receiver 98. The second interface controller 108 may receive the transaction layer packet, wherein the receiver 98 includes second logic 110 (e.g., logic instructions, configurable logic, fixed-functionality hardware logic, etc., or any combination thereof) to coordinate with the transmitter 100 to prevent the transaction layer packet from violating the address boundary constraint.

As already noted, the address boundary constraint might prohibit an address and length combination of the transaction layer packet from crossing a particular boundary (e.g., 4-KB boundary). Additionally, the transaction layer packet may be one of a memory write packet or a memory read packet. The IO module 78 may also include a receiver 112 that operates similarly to the receiver 98, wherein the memory controller 96 may include a transmitter 114 that operates similarly to the transmitter 100. Moreover, the processor 88 may be configured to communicate with the system memory 92 in a fashion that is similar to the communications between the IO module 78 and the mass storage 82.

The memory structure 94 may include either volatile memory or non-volatile memory. Non-volatile memory is a storage medium that does not require power to maintain the state of data stored by the medium. In one embodiment, the memory structure 94 is a block addressable storage device, such as those based on NAND or NOR technologies. A storage device may also include future generation nonvolatile devices, such as a three dimensional (3D) crosspoint memory device, or other byte addressable write-in-place nonvolatile memory devices. In one embodiment, the storage device may be or may include memory devices that use silicon-oxide-nitride-oxide-silicon (SONOS) memory, electrically erasable programmable read-only memory (EEPROM), chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The storage device may refer to the die itself and/or to a packaged memory product. In some embodiments, 3D crosspoint memory may comprise a transistor-less stackable cross point architecture in which memory cells sit at the intersection of word lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of the memory modules complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards and communication interfaces of the storage devices that implement such standards may be referred to as DDR-based interfaces.

FIG. 6 shows a semiconductor package apparatus 120 (e.g., chip, die) that includes one or more substrates 122 (e.g., silicon, sapphire, gallium arsenide) and logic 124 (e.g., transistor array and other integrated circuit/IC components) coupled to the substrate(s) 122. The logic 124, which may be implemented at least partly in configurable logic and/or fixed-functionality hardware logic, may generally implement one or more aspects of the method 20 (FIG. 2), the method 32 (FIG. 3A) and/or the method 40 (FIG. 3B). Thus, the logic 124 may add, by a transmitter, non-address metadata to a memory address field of a transaction layer packet, wherein the non-address metadata includes one or more vendor-specific attributes. Additionally, the logic 124 may coordinate, by the transmitter, with a receiver to prevent the transaction layer packet from violating an address boundary constraint associated with an interface and send, by a first interface controller, the transaction layer packet to the receiver via the interface. The logic 124 may also receive, by a second interface controller, the transaction layer packet from the interface and coordinate, by the receiver, with the transmitter to prevent the transaction layer packet from violating the address boundary constraint.

In one example, the logic 124 includes transistor channel regions that are positioned (e.g., embedded) within the substrate(s) 122. Thus, the interface between the logic 124 and the substrate(s) 122 may not be an abrupt junction. The logic 124 may also be considered to include an epitaxial layer that is grown on an initial wafer of the substrate(s) 122.

### Additional Notes and Examples

Example 1 may include a performance-enhanced computing system comprising a memory structure, a memory controller coupled to the memory structure, the memory controller including a receiver, an interface, a host processor including a transmitter, the transmitter including first logic to add non-address metadata to a memory address field of a transaction layer packet, wherein the non-address metadata includes one or more vendor-specific attributes and wherein the first logic is to coordinate with the receiver to prevent the transaction layer packet from violating an address boundary constraint associated with the interface, a first interface controller coupled to the interface and the transmitter, the first interface controller to send the transaction layer packet to the receiver via the interface, and a second interface controller coupled to the interface and the receiver, the second interface controller to receive the transaction layer packet from the interface, wherein the receiver includes second logic to coordinate with the transmitter to prevent the transaction layer packet from violating the address boundary constraint.

Example 2 may include the system of Example 1, wherein the address boundary constraint is to prohibit an address and length combination of the transaction layer packet from crossing a 4-KB boundary.

Example 3 may include the system of Example 1, wherein the non-address metadata is to be added to a lower bit range of the memory address field, wherein the first logic is to subtract a known value from an upper bit range of the memory address field, wherein the non-address metadata further includes an address adjustment indicator, and wherein the second logic is to detect the address adjustment indicator in the non-address metadata and add the known value to the upper bit range in response to the address adjustment indicator.

Example 4 may include the system of Example 1, wherein the first logic is to add the non-address metadata to a predetermined and fixed upper bit range of the memory address field, and wherein the second logic is to decode the non-address metadata from the predetermined and fixed upper bit range to obtain the one or more vendor-specific attributes.

Example 5 may include the system of Example 1, wherein the transaction layer packet is to be one of a memory write packet or a memory read packet.

Example 6 may include the system of Example 1, wherein the interface is a Peripheral Components Interconnect Express (PCI-e) interface.

Example 7 may include a transmitter comprising one or more substrates, and logic coupled to the one or more substrates, wherein the logic is implemented in one or more of configurable logic or fixed-functionality hardware logic, the logic coupled to the one or more substrates to add non-address metadata to a memory address field of a transaction layer packet, wherein the non-address metadata is to include one or more vendor-specific attributes, coordinate with a receiver to prevent the transaction layer packet from violating an address boundary constraint associated with an interface, and send the transaction layer packet to the receiver via the interface.

Example 8 may include the transmitter of Example 7, wherein the address boundary constraint is to prohibit an address and length combination of the transaction layer packet from crossing a 4-KB boundary.

Example 9 may include the transmitter of Example 7, wherein the non-address metadata is added to a lower bit range of the memory address field, wherein the logic is to subtract a known value from an upper bit range of the memory address field, and wherein the non-address metadata further includes an address adjustment indicator.

Example 10 may include the transmitter of Example 7, wherein the non-address metadata is added to a predetermined and fixed upper bit range of the memory address field.

Example 11 may include the transmitter of Example 7, wherein the transaction layer packet is to be one of a memory write packet or a memory read packet.

Example 12 may include the transmitter of Example 7, wherein the transaction layer packet is sent via a Peripheral Components Interconnect Express (PCI-e) interface.

Example 13 may include a receiver comprising one or more substrates, and logic coupled to the one or more substrates, wherein the logic is implemented in one or more of configurable logic or fixed-functionality hardware logic, the logic coupled to the one or more substrates to receive a transaction layer packet from an interface, wherein a memory address field of the transaction layer packet is to include non-address metadata and the non-address metadata is to include one or more vendor-specific attributes, and coordinate with a transmitter to prevent the transaction layer packet from violating an address boundary constraint associated with the interface.

Example 14 may include the receiver of Example 13, wherein the address boundary constraint is to prohibit an address and length combination of the transaction layer packet from crossing a 4-KB boundary.

Example 15 may include the receiver of Example 13, wherein the non-address metadata is to be located in a lower bit range of the memory address field and the logic is to detect an address adjustment indicator in the non-address metadata, and add a known value to an upper bit range of the memory address field in response to the address adjustment indicator.

Example 16 may include the receiver of Example 13, wherein the logic is to decode the non-address metadata from a predetermined and fixed upper bit range of the memory address field to obtain the one or more vendor-specific attributes.

Example 17 may include the receiver of Example 13, wherein the transaction layer packet is to be one of a memory write packet or a memory read packet.

Example 18 may include the receiver of Example 13, wherein the transaction layer packet is received from a Peripheral Components Interconnect Express (PCI-e) interface.

Example 19 may include a method comprising adding, by a transmitter, non-address metadata to a memory address field of a transaction layer packet, wherein the non-address metadata includes one or more vendor-specific attributes, coordinating, by the transmitter, with a receiver to prevent the transaction layer packet from violating an address boundary constraint associated with an interface, sending, by a first interface controller, the transaction layer packet to the receiver via the interface, receiving, by a second interface controller, the transaction layer packet from the interface, and coordinating, by the receiver, with the transmitter to prevent the transaction layer packet from violating the address boundary constraint.

Example 20 may include the method of Example 19, wherein the address boundary constraint prohibits an address and length combination of the transaction layer packet from crossing a 4-KB boundary.

Example 21 may include the method of Example 19, wherein the non-address metadata is added to a lower bit range of the memory address field, wherein coordinating with the receiver includes subtracting, by the transmitter, a known value from an upper bit range of the memory address field, wherein the non-address metadata further includes an address adjustment indicator, and wherein coordinating with the transmitter includes detecting, by the receiver, the address adjustment indicator in the non-address metadata and adding, by the receiver, the known value to the upper bit range in response to the address adjustment indicator.

Example 22 may include the method of Example 19, wherein coordinating with the receiver includes adding, by the transmitter, the non-address metadata to a predetermined and fixed upper bit range of the memory address field and coordinating with the transmitter includes decoding, by the receiver, the non-address metadata from the predetermined and fixed upper bit range to obtain the one or more vendor-specific attributes.

Example 23 may include the method of Example 19, wherein the transaction layer packet is one of a memory write packet or a memory read packet.

Example 24 may include the method of Example 19, wherein the transaction layer packet is exchanged via a Peripheral Components Interconnect Express (PCI-e) interface.

Technology described herein may therefore maintain full PCI-e standard/specification compliance, which enables full reusability of off-the-shelf PCI-e controller (e.g., transaction, line, physical layer) components, while achieving advanced functionality through new memory architectures (e.g., two level memory/2LM). As a result, system design, validation and product time-to-market may be enhanced. Limiting implementation to the application layer of the SoC and/or memory device further simplifies deployment and reduces cost. Indeed, maximum memory addressability flexibility up to, for example, 64-bit addressing may be achieved while enabling new functionality. The technology described herein enhances performance by eliminating usage restrictions, improving compatibility (e.g., with respect to root controller/endpoint validation) across different component vendors and/or increasing bus/interface efficiency.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a memory structure;
a memory controller coupled to the memory structure, the memory controller including a receiver;
an interface;
host processor including a transmitter, the transmitter including first logic to add non-address metadata to a memory address field of a transaction layer packet, wherein the non-address metadata includes one or more vendor-specific attributes and wherein the first logic is to coordinate with the receiver to prevent the transaction layer packet from violating an address boundary constraint associated with the interface;
a first interface controller coupled to the interface and the transmitter, the first interface controller to send the transaction layer packet to the receiver via the interface; and
a second interface controller coupled to the interface and the receiver, the second interface controller to receive the transaction layer packet from the interface, wherein the receiver includes second logic to coordinate with the transmitter to prevent the transaction layer packet from violating the address boundary constraint.

2. The system of claim 1, wherein the address boundary constraint is to prohibit an address and length combination of the transaction layer packet from crossing a 4-KB boundary.

3. The system of claim 1, wherein the non-address metadata is to be added to a lower bit range of the memory address field, wherein the first logic is to subtract a known value from an upper bit range of the memory address field, wherein the non-address metadata further includes an address adjustment indicator, and wherein the second logic is to detect the address adjustment indicator in the non-address metadata and add the known value to the upper bit range in response to the address adjustment indicator.

4. The system of claim 1, wherein the first logic is to add the non-address metadata to a predetermined and fixed upper bit range of the memory address field, and wherein the second logic is to decode the non-address metadata from the predetermined and fixed upper bit range to obtain the one or more vendor-specific attributes.

5. The system of claim 1, wherein the transaction layer packet is to be one of a memory write packet or a memory read packet.

6. The system of claim 1, wherein the interface is a Peripheral Components Interconnect Express (PCI-e) interface.

7. A transmitter comprising:
one or more substrates; and
logic coupled to the one or more substrates, wherein the logic is implemented in one or more of configurable logic or fixed-functionality hardware logic, the logic coupled to the one or more substrates to:
add non-address metadata to a memory address field of a transaction layer packet, wherein the non-address metadata is to include one or more vendor-specific attributes,
coordinate with a receiver to prevent the transaction layer packet from violating an address boundary constraint associated with an interface, and
send the transaction layer packet to the receiver via the interface.

8. The transmitter of claim 7, wherein the address boundary constraint is to prohibit an address and length combination of the transaction layer packet from crossing a 4-KB boundary.

9. The transmitter of claim 7, wherein the non-address metadata is added to a lower bit range of the memory address field, wherein the logic is to subtract a known value from an upper bit range of the memory address field, and wherein the non-address metadata further includes an address adjustment indicator.

10. The transmitter of claim 7, wherein the non-address metadata is added to a predetermined and fixed upper bit range of the memory address field.

11. The transmitter of claim 7, wherein the transaction layer packet is to be one of a memory write packet or a memory read packet.

12. The transmitter of claim 7, wherein the transaction layer packet is sent via a Peripheral Components Interconnect Express (PCI-e) interface.

13. A receiver comprising:
one or more substrates; and
logic coupled to the one or more substrates, wherein the logic is implemented in one or more of configurable logic or fixed-functionality hardware logic, the logic coupled to the one or more substrates to:
receive a transaction layer packet from an interface, wherein a memory address field of the transaction layer packet is to include non-address metadata and the non-address metadata is to include one or more vendor-specific attributes; and
coordinate with a transmitter to prevent the transaction layer packet from violating an address boundary constraint associated with the interface.

14. The receiver of claim 13, wherein the address boundary constraint is to prohibit an address and length combination of the transaction layer packet from crossing a 4-KB boundary.

15. The receiver of claim 13, wherein the non-address metadata is to be located in a lower bit range of the memory address field and the logic is to:
detect an address adjustment indicator in the non-address metadata, and add a known value to an upper bit range of the memory address field in response to the address adjustment indicator.

16. The receiver of claim 13, wherein the logic is to decode the non-address metadata from a predetermined and fixed upper bit range of the memory address field to obtain the one or more vendor-specific attributes.

17. The receiver of claim 13, wherein the transaction layer packet is to be one of a memory write packet or a memory read packet.

18. The receiver of claim 13, wherein the transaction layer packet is received from a Peripheral Components Interconnect Express (PCI-e) interface.

19. A method comprising:
adding, by a transmitter, non-address metadata to a memory address field of a transaction layer packet, wherein the non-address metadata includes one or more vendor-specific attributes;
coordinating, by the transmitter, with a receiver to prevent the transaction layer packet from violating an address boundary constraint associated with an interface;
sending, by a first interface controller, the transaction layer packet to the receiver via the interface;
receiving, by a second interface controller, the transaction layer packet from the interface; and
coordinating, by the receiver, with the transmitter to prevent the transaction layer packet from violating the address boundary constraint.

20. The method of claim 19, wherein the address boundary constraint prohibits an address and length combination of the transaction layer packet from crossing a 4-KB boundary.

21. The method of claim 19, wherein the non-address metadata is added to a lower bit range of the memory address field, wherein coordinating with the receiver includes subtracting, by the transmitter, a known value from an upper bit range of the memory address field, wherein the non-address metadata further includes an address adjustment indicator, and wherein coordinating with the transmitter includes detecting, by the receiver, the address adjustment indicator in the non-address metadata and adding, by the receiver, the known value to the upper bit range in response to the address adjustment indicator.

22. The method of claim 19, wherein coordinating with the receiver includes adding, by the transmitter, the non-address metadata to a predetermined and fixed upper bit range of the memory address field and coordinating with the transmitter includes decoding, by the receiver, the non-address metadata from the predetermined and fixed upper bit range to obtain the one or more vendor-specific attributes.

23. The method of claim 19, wherein the transaction layer packet is one of a memory write packet or a memory read packet.

24. The method of claim 19, wherein the transaction layer packet is exchanged via a Peripheral Components Interconnect Express (PCI-e) interface.
